(19) United States
(12) Patent Application Publication
(10) Pub. No.: US 2008/0226090 A1
(43) Pub. Date: Sep. 18, 2008

(54) Oscillation/Echo Canceller System

(76) Inventor: Shinji Seto, Kasuya-gun Fukuoka (JP)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 10/593,677

(22) PCT Filed: Mar. 24, 2005
(86) PCT No.: PCT/JP2005/005333

§ 371 Date: Sep. 21, 2006

(30) Foreign Application Priority Data
Mar. 25, 2004 (JP) 2004-088170

(51) Int. Cl. H04B 3/20

(52) U.S. Cl. 381/66

(57) ABSTRACT

An oscillation/echo canceller system (1) comprising a hollow main body (5) having an insert section (4) provided with an opening (3) and adapted to be inserted into the canal of the ear, a microphone (10) and a speaker (11), the microphone (10) and the speaker (11) being arranged in the main body. The speaker is arranged with its sound emitting hole directed to the opening of the insert section and provided with an even number of sound emitting canals (12) formed between the sound emitting hole and the opening and having identical lengths and identical inner diameters, the even number being equal to two or even number times of two. The microphone is arranged more remotely from the opening of the insert section than the sound emitting hole of the speaker and the microphone has a sound collecting canal (15) for collecting sounds from the opening that is made of a material incapable of directly collecting sounds from the sound emitting canals of the speaker.

### FIELD OF THE INVENTION

This invention relates to an oscillation/echo canceller system that is effective for preventing oscillations/echoes of a communication apparatus, which may be a mobile communication apparatus such as a portable phone, a PHS or some other mobile phone, a wired phone, an earphone/microphone set, a machine translator, a loudspeaker for those whose vocal cords are damaged and deaf-mute people, a communication apparatus for travel agents for guidance, a communication apparatus for announcers, a communication apparatus for train conductors, a headset for telephone operators or some other communication apparatus.

### DESCRIPTION OF RELATED ART

Portable telephone sets, PHS sets and other mobile communication apparatus that can be used as wired and wireless slave telephone sets are known. Communication systems have been proposed for the purpose of bidirectional communications between such a slave set and the communication apparatus at the end of the line by way of the master set and a transmission system including a wireless radio wave relay service such as the one provided by NTT Do Co Mo in Japan (see, for example, Jpn. Pat. Appln. Laid-Open Publication No. 2002-300074).

Such a communication system typically includes at least a pair of communication apparatus arranged at the opposite end of the line. Each of the communication apparatus comprises a transmitter including a microphone and an amplifier circuit necessary for transmitting sound signals and other signals and a receiver including a speaker or an earphone and an amplifier circuit necessary for receiving sound signals and other signals. The two communication apparatus are operated for bidirectional communications by way of the transmission system.

In bidirectional communications, an oscillation phenomenon and/or an echo phenomenon can appear when a loop is formed by an electric coupling to involve sound waves being transmitted in the spaces in the transmitters/receivers of the two communication apparatus. An oscillation phenomenon appears when the loop gain of the electric coupling is not less than 1, whereas an echo phenomenon appears when the loop gain of the electric coupling is not more than 1. Therefore, it is not possible to bring the transmitter and the receiver close to each other to say nothing of integrating or arranging side by side the transmitter and the receiver in the state of the art. Thus, this constitutes a large problem in terms of anti-noise measures of communication apparatus and efforts for realizing downsized and lightweight communication apparatus at low manufacturing cost regardless if apparatus are wired or wireless.

It is therefore the object of the present invention to provide an oscillation/echo canceller system that dissolves the above identified problem of the prior art and allows a communication apparatus of the type under consideration to bidirectionally communicate with an external transmitter/receiver on a stable basis without giving rise to oscillation phenomena and echo phenomena.

### SUMMARY OF THE INVENTION

According to the invention, the above object is achieved by providing an oscillation/echo canceller system comprising a hollow main body having an insert section provided with an opening and adapted to be inserted into the canal of the ear, a microphone for taking sound signals being transmitted as air vibrations into the main body by way of the opening of the insert section and a speaker realized as a tightly closed object except a sound emitting hole and adapted to boost the sound signals received from an external transmitter/receiver, the oscillation/echo canceller system being designed to establish a bidirectional communication with an external transmitter/receiver when the insert section is removably inserted into an ear canal; the speaker being arranged with its sound emitting hole directed to the opening of the insert section and provided with an even number of sound emitting canals formed between the sound emitting hole and the opening and having identical lengths and identical inner diameters, the even number being equal to two or even number times of two; the microphone being arranged more remotely from the opening of the insert section than the sound emitting hole of the speaker, the sound collecting canal of the microphone for collecting sounds from the opening being made of a material incapable of directly collecting sounds from the sound emitting canales of the speaker.

Thus, an oscillation/echo canceller system according to the invention having the above-described configuration cancels both the oscillation phenomenon and the echo phenomenon in a bidirectional communication with an external transmitter/receiver and hence can realize a stable bidirectional communication with the external transmitter/receiver. Therefore, an oscillation/echo canceller system according to the invention is very useful and really epoch-making because it can completely eliminate oscillations and echoes in a communication apparatus if compared with conventional costly oscillation/echo canceling circuits that have to be installed in communication apparatus.

### BRIEF DESCRIPTION OF THE DRAWINGS

FIG. 1 is a schematic longitudinal cross sectional front view of an embodiment of oscillation/echo canceller system according to the invention, part of which is omitted; and

FIG. 2 is a schematic lateral view of the embodiment of FIG. 1 as viewed from the left of FIG. 1.

### DETAILED DESCRIPTION OF THE PREFERRED EMBODIMENT

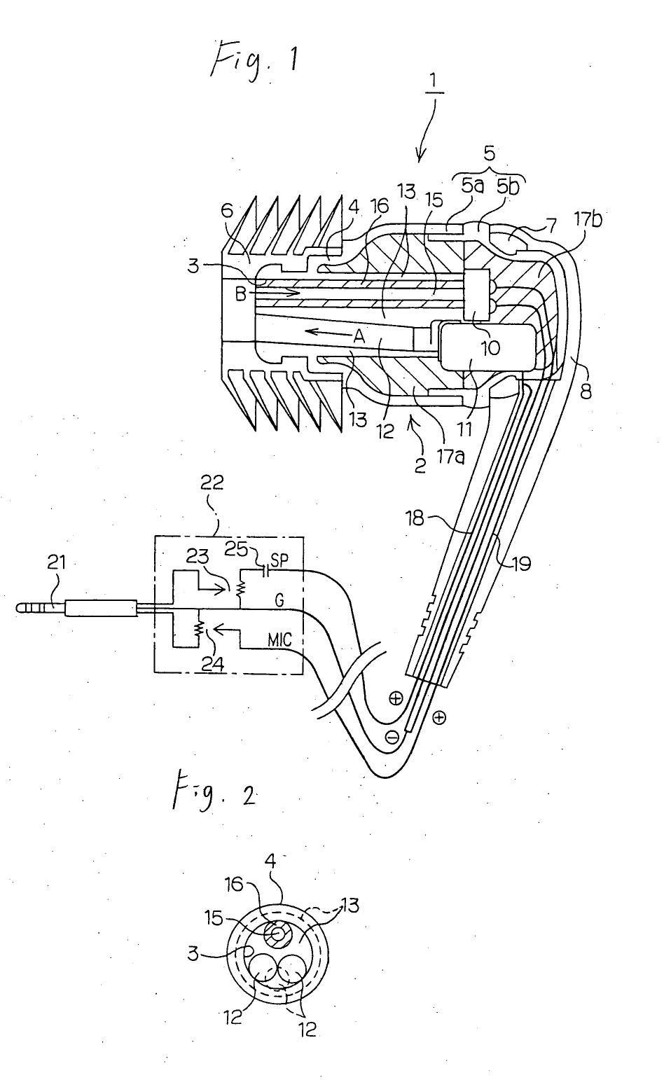

Now, the present invention will be described in greater detail by referring to the accompanying drawings that illustrate a preferred embodiment of the invention. Referring to FIGS. 1 and 2, the embodiment of oscillation/echo canceller system 1 comprises an earphone/microphone 2 as a principal component thereof. The earphone/microphone 2 has a hollow main body 5 that includes an insert section 4 formed with an opening 3 to show dimensions that make it to be suitably inserted into an ear canal. The main body 5 is made of synthetic resin and has a substantially cylindrical profile so as to show a circular cross section as viewed from a lateral side. The main body 5 has not any opening except the opening 3 of the insert section 4 and hence the hollow inside thereof is tightly closed. The insert section 4 projects from a middle part of a lateral side of the main body 5 and an ear pad 6 that is made of a resilient elastic material such as rubber and adapted to be tightly held in contact with the surface of an ear canal (external auditory canal) regardless of the size of the ear canal is press-fit to the front end of the insert section 4. The main body 5 includes a half 5a arranged at the side of the ear pad 6 and another half 5b arranged at the other side, which halves are put together by press-fitting. A ring member 7 is arranged on the outer periphery of the half 5b and a tubular body 8 containing electric wires and so on, which will be described in greater detail hereinafter, is press-fit to the main body 5 at en enlarged end opening of the tubular body 8 to produce an integrated earphone/microphone 2. Thus, as described above, the earphone/microphone 2 will be removably fitted to the ear canal of the ear as the insert section 4 is inserted in the ear canal.

The main body 5 contains therein a microphone 10 for taking in sound signals being transmitted as air vibrations by way of the opening 3 of the insert section 4 and a speaker 11 for boosting the sound signals received from an external transmitter/receiver (not shown), which speaker 11 is an object tightly closed except a sound emitting hole it has. The speaker 11 is arranged with the sound emitting hole (not shown) directed to the opening 3 of the insert section 4 and two sound emitting canals 12 having identical lengths and identical inner diameters are branched from the sound emitting hole to extend toward the opening 3. The walls of the sound emitting canals 12 are made of synthetic resin 13 and formed integrally with the main body 5. The synthetic resin 13 of the walls of the sound emitting canals 12 extends from the insert section 4 of the main body 5 toward the opposite side of the opening 3 and its outer periphery shows a circular cross section. While this embodiment has two sound emitting canals 12, it may alternatively have four or more than four sound emitting canals 12 provided that the number of sound emitting canals is equal to even number times of two.

The microphone 10 is arranged at a position more remote than the sound emitting holes of the speaker 11 relative to the opening 3 of the insert section 4 and has a sound collecting canal 15 adapted to collect sounds from the opening 3 and its wall is formed by a resilient elastic body 16 that is made of a resilient material such as rubber not capable of directly collecting sounds from the sound emitting canals 12 of the speaker 11. The resilient elastic body 16 is a hollow cylindrical body and its center hole operates as sound collecting canal 15, while its outer peripheral surface is held in contact with the synthetic resin 13. Since the sound emitting canals 12 of the speaker 11 and the sound collecting canal 15 of the microphone 10 are respectively formed by the synthetic resin 13 and the resilient elastic body 16, the mechanical vibrations of the speaker 11 are suppressed by them and hence not directly transmitted to the microphone 10 so that it is possible to collect only the sound of the vibrations entering the sound colleting canal 15 from the sound emitting canals 12 by way of the opening 3. In FIG. 1, reference symbols 17a, 17b denote two separate sound insulating members that are filled in the main body 5 in a hermetically sealed state. Lining member (not shown) are arranged respectively along the oppositely disposed surfaces and the other surfaces, which are held in contact with the other members 13, 5 and the devices 10, 11, of the sound insulating members 17a, 17b and the oppositely disposed surfaces are held in a state where they are pressed by pressure of a predetermined level in order to prevent vibrations and sounds coming in from the outside from being transmitted further through them.

The sound emitting canals 12 of the speaker 11 and the sound collecting canal 15 of the microphone 10 extend linearly and are located within the area defined by the inner diameter of the opening 3. The electric wires 18, 19 extending from the speaker 11 and the microphone 10 by a predetermined length are contained in the above-described tubular body 8 and connected at the remote ends thereof to an earphone jack 21 to be forced into the earphone jack hole of the external transmitter/receiver. An output reduction circuit 22 is arranged as output reduction means on the electric wires 18, 19 near the earphone jack 21. The output reduction circuit 22 includes variable resistors 23, 24 for respectively changing the electric resistances of the electric wires 18, 19 and a capacitor 25 arranged on the electric wire 18 at the side of the speaker 11 so that the output of the speaker 11 can be reduced to not higher than 70% of its output level and the output of the microphone 10 can be reduced to not higher than one tenth of its output level that are observed when the speaker 11 and the microphones 10 are operated in open air. The capacitor 25 is provided to prevent swerves of sound signals from taking place.

While the output reduction circuit 22 is arranged on the electric wires 18, 19 in this embodiment, it may alternatively be arranged at any other appropriate place in the main body 5 or in the external transmitter/receiver. The external transmitter/receiver may be a mobile communication apparatus such as a portable telephone or a PHS or a transmitter/receiver dedicated to an earphone/microphone set contained in or externally attached to a communication terminal or some other communication apparatus.

Now, the operation of the above-described embodiment will be described below. When transmitting/receiving sound signals, the ear pad 6 fitted to the insert section 4 of the earphone/microphone 2 of the oscillation/echo canceller system 1 is inserted into one of the external auditory canals of the user until it is tightly held in contact with the canal and the earphone jack 21 is forced into the earphone jack hole of the external transmitter/receiver. For receiving sound signals, the sound signals transmitted from the external transmitter/receiver are received by the earphone microphone 2 by way of the earphone jack 21 and the electric wire 18 and boosted by the speaker 11 before they are transmitted outwardly by way of the sound emitting canals 12 to the tympanic membrane of the ear located at the distal end of the external auditory canal. At this time, it may be apprehended that sounds may leak from the walls of the sound emitting canals 12 to the sound collecting canal 15 of the microphone 10, the transmission of such leaked sounds is suppressed by the synthetic resin 13 and the resilient elastic body 16 and hence sounds do not practically leak at all.

For transmitting sounds, on the other hand, the sound signals generated by the vocal cords of the user and transmitted as vibrations of air coming from the tympanic membrane through the external auditory canal proceed through the opening 3 in the direction of arrow B in FIG. 1 and are taken up by the microphone 10. Then, they are transmitted to the external transmitter/receiver by way of the electric wire 19 and the earphone jack 21. Neither an echo phenomenon nor a vibration phenomenon arises when transmitting and/or receiving sound signals.

More specifically, echoes are completely eliminated because (1) the microphone 10 is arranged at a position more remote from the opening 3 of the insert section 4 than the sound emitting holes of the speaker 11 and the position is a low pressure spot where no sound pressure is applied directly from the speaker 11, (2) the sound signals boosted by the speaker 11 are transmitted only from the two sound emitting canals 12 to the tympanic membrane that is found at the distal end of the external auditory canal that attenuates the sound signals so that generation of echoes is suppressed and the sounds that operate as echo components, if any, can hardly get to the microphone 10 located remote from the sound signals, (3) the sound signals in the external auditory canal transmitted from the two sound emitting canals 12 give rise to inversion of phases as they are mixed with each other to cancel echo components unless they are amplified by reverberation and (4) while the speaker 11 emits sounds showing proper phases from the sound transmitting holes, the sounds showing an inverted phase that are inevitably produced by an intrinsic physical property of the speaker are absorbed in the inside of the speaker having a hermetically sealed structure and extinguished by the attenuation holes it has. Thus, the echoes that are generated when the loop gain is not more than 1 are constantly attenuated so that echoes can hardly give rise problems.

Additionally, the output of the speaker 11 is suppressed to not higher than 70% of its output level and the output of the microphone 10 is suppressed to not higher than one tenth of its output level by the output reduction circuit 22 so that the loop gain that is the cause of oscillations is held to not more than land hence no oscillation phenomenon occurs.

It may be appreciated that the output reduction circuit 22 of the above-described embodiment is an example of means for reducing the output of the speaker 11 to not higher than 70% of its output level and the output of the microphone 10 to not higher than one tenth of its output level and therefore, a circuit other than the illustrated one may alternatively be used for the purpose of the present invention.

What is claimed is:

1. An oscillation/echo canceller system comprising a hollow main body having an insert section provided with an opening and adapted to be inserted into the canal of the ear, a microphone for taking sound signals being transmitted as air vibrations into the main body by way of the opening of the insert section and a speaker realized as a tightly closed object except a sound emitting hole and adapted to boost the sound signals received from an external transmitter/receiver, the oscillation/echo canceller system being designed to establish a bidirectional communication with an external transmitter/receiver when the insert section is removably inserted into an ear canal;
the speaker being arranged with its sound emitting hole directed to the opening of the insert section and provided with an even number of sound emitting canals formed between the sound emitting hole and the opening and having identical lengths and identical inner diameters, the even number being equal to two or even number times of two;
the microphone being arranged more remotely from the opening of the insert section than the sound emitting hole of the speaker, the sound collecting canal of the microphone for collecting sounds from the opening being made of a material incapable of directly collecting sounds from the sound emitting canals of the speaker.

2. The system according to claim 1, wherein the sound emitting canals of the speaker and the sound collecting canal of the microphone extend linearly and are located within the area defined by the inner diameter of the opening of the insert section.

3. The system according to claim 1, wherein the surrounding wall of the sound collecting canal of the microphone is formed by a resilient elastic body that is made of a resilient material such as rubber.

4. The system according to claim 1, wherein the surrounding walls of the sound emitting canals of the speaker are made of synthetic resin.

5. The system according to claim 1, wherein the electric wires extending from the speaker and the microphone are connected to an earphone jack to be inserted into the earphone jack hole of the external transmitter/receiver.

6. The system according to claim 1, further comprising:
means for reducing the output of the speaker to not higher than 70% of its output level and the output of the microphone to not higher than one tenth of its output level.

7. The system according to claim 6, wherein the output reduction means is an output reduction circuit arranged on the electric wires or in the main body.
